(19) United States
(12) Patent Application Publication
(10) Pub. No.: US 2015/0308410 A1
(43) Pub. Date: Oct. 29, 2015

(54) AIRBORNE WIND ENERGY SYSTEM FOR ELECTRICITY GENERATION, ENERGY STORAGE, AND OTHER USES

(71) Applicant: Leonid Goldstein, Austin, TX (US)

(72) Inventor: Leonid Goldstein, Austin, TX (US)

(21) Appl. No.: 14/746,813

(22) Filed: Jun. 22, 2015

Related U.S. Application Data
(63) Continuation of application No. PCT/US13/73766, filed on Dec. 8, 2013.
(60) Provisional application No. 61/746,238, filed on Dec. 27, 2012.
(60) Provisional application No. 61/747,446, filed on Dec. 31, 2012.
(60) Provisional application No. 61/760,150, filed on Feb. 3, 2013.
(60) Provisional application No. 61/762,257, filed on Feb. 7, 2013.
(60) Provisional application No. 61/771,197, filed on Mar. 1, 2013.
(60) Provisional application No. 61/872,956, filed on Sep. 3, 2013.

(51) Int. Cl. F03D 9/00; F03D 5/02; F01D 13/02; F03D 11/04

(52) U.S. Cl. CPC F03D 9/002; F03D 11/04; F03D 5/02; F01D 13/02; F05B 2240/92; F05D 2220/32

(57) ABSTRACT

Airborne wind energy system converting power of wind into power forms suitable for various industrial processes. That includes converting wind energy into internal energy of hot compressed gas, such as air or steam, and subsequent use of this energy for energy storage, synthetic fuel production, electricity generation, and other purposes. Pumped hydro energy storage, powered by airborne wind energy. A combined power plant, using natural gas combustion and wind power. A wind farm with a firm capacity, using wind driven energy storage together with electricity producing wind turbines or AWECS.

### CROSS REFERENCE TO RELATED APPLICATIONS

This application is a continuation of PCT Application No. PCT/US13/73766, filed 8 Dec. 2013, which claims the benefit of U.S. Provisional Applications No. 61/746,238, filed 27 Dec. 2012, No. 61/747,446, filed 31 Dec. 2012, No. 61/760,150, filed 3 Feb. 2013, No. 61/762,257, filed 7 Feb. 2013, No. 61/771,197, filed 1 Mar. 2013, and No. 61/872,956, filed 3 Sep. 2013 by the same inventor as herein, the entire disclosure of which is incorporated herein by reference.

### BACKGROUND OF THE INVENTION

The invention is generally directed to a device and a method for using wind power, utilizing an airborne wind energy harvesting member.

The classical work in the airborne wind energy conversion systems (AWECS) is the article by Miles L. Loyd “Crosswind Kite Power” (Energy Journal, 1980; 4:106-11), in which the author disclosed a wind energy harvesting device, comprising a tethered wing, flying cross wind and harvesting wind energy, and transferring harvested energy to a ground based generator via motion of the tether. Crosswind motion of a wing is much more efficient, than downwind motion, allowing the wing to fly many times speed of the wind and harvest energy from an area, many times larger than the area of the wing. The article has also offered two ways of converting harvested mechanical energy into electrical energy.

U.S. Pat. No. 3,987,987 by Payne and McCutchen was even earlier important contribution to development of the airborne wind energy conversion systems.

U.S. Pat. Nos. 7,504,741 & 7,546,813 by Wrage et al, U.S. Pat. No. 8,080,889 by Ippolito et al, U.S. Pat. No. 6,523,781 by Ragner discuss mechanical transfer of the harvested wind energy from the airborne member to an electrical generator on the ground using reel out of the tether.

Additionally, U.S. Pat. No. 7,504,741 by Wrage et al teaches a specific system for conversion of wind energy into mechanical energy. It mentions possibility of using a hydraulic cylinder and a hydraulic motor for converting mechanical energy delivered by the tether into electricity, but does not disclose how to do that.

U.S. Pat. No. 8,196,395 by Fong et al discusses advanced methods of compressed air energy storage, including in connection with conventional wind turbines, but not with airborne wind energy systems. U.S. Pat. No. 7,081,688 by Satou et al discusses energy storage and recovery systems, including heat storage, without connection to wind power. U.S. patent application Ser. No. 12/280,739 by Chen et al discusses another type of energy storage system, utilizing compressed air and cryogenic storage. U.S. patent application Ser. No. 12/681,586 by Howes et al discusses yet another type of energy storage, involving compressing gas and both hot and cold storage tanks. The article “KiteGen project: control as key technology for a quantum leap in wind energy generators” by Canale et al (Proc. of American Control Conference, New York 2007) discusses control of a kite, used as an airborne member in an airborne wind energy conversion system.

None of the references above teach efficient conversion of wind power into anything else but vehicle propulsion and electricity generation. More specifically, they do not teach conversion of wind energy into other forms of energy than electricity, storing harvested wind energy in energy storage, providing wind power stations with a firm capacity, independent of the wind. They do not teach conversion of wind power, harvested by airborne wings or kites, into electricity through pneumatic or hydraulic action. They do not teach conversion of wind power into heat, compressed air or other forms, suitable for powering industrial processes.

International patent applications PCT/US12/66331, PCT/US12/67143, PCT/US13/30314, and PCT/US13/51419 by this inventor teach multiple airborne wind energy conversion systems, focusing mostly on the electricity generation. International patent application PCT/US12/71582 by this inventor focuses mostly on the energy storage.

The current invention is directed to solving the above mentioned shortcomings in the existing art and teaching a cost efficient airborne wind energy conversion system, capable of providing not only electrical energy, but other forms of energy as well, including energy forms more suitable for storage and powering industrial processes.

### SUMMARY OF THE INVENTION

The invention is generally directed to a device and a method for using wind power, utilizing an airborne wind energy harvesting member.

AWECS is an abbreviation of airborne wind energy conversion system. As used herein, AWECS means a wind energy conversion system, in which the wind engaging member(s) are airborne.

One embodiment of the invention is a device for converting wind energy into internal energy of gas, comprising: an airborne member, adapted to harvest wind energy; a tether, attaching the airborne member to the ground; a gas compressor at the ground level, coupled to the airborne member.

In this device, the gas compressor may utilize at least one gas tight piston, coupled to the tether, as the surface to compress the gas. Another aspect of the invention is an industrial plant, comprising the device from the first embodiment above, adapted to produce hot gas, further comprising a subsystem for utilization of the produced hot gas in an industrial process. The industrial process may be oil extraction, synthetic fuel production, hydrocarbons cracking, water desalination or other.

Another embodiment of the invention is energy storage device, comprising the device from the first embodiment above and: a storage medium, adapted to receive the internal energy of the gas; a heat engine, adapted to use the energy from the storage medium; an electrical generator, driven by the heat engine. The storage medium may contain compressed air, supercritical water, heated liquid or solid. The storage medium may comprise sorptive substance. Most of the energy may be stored in the form of sensitive heat or latent heat.

Another embodiment of the invention is a natural gas power plant, comprising the device from first embodiment above, adapted to compress air in which the natural gas combusts.

Another embodiment of the invention is a wind power plant, comprising: a first airborne wind energy conversion system, comprising an electrical generator, adapted to convert power of wind into electrical power; an energy storage; a second airborne wind energy conversion system, adapted to convert power of wind into internal energy of matter, stored in the energy storage; an energy conversion system, comprising an electrical generator, adapted to convert the internal energy of matter, stored in the energy storage, into electrical power. Further, the power plant may be designed to produce at least a pre-defined minimum power for at least pre-defined percentage of time. Further, the pre-defined percentage of time may be at least 80%.

Another embodiment of the invention is a method for converting wind energy into internal energy of gas, comprising steps of: harvesting wind energy using an airborne member, attached by a tether to the ground; providing a gas compressor at the ground level, coupled to the airborne member; compressing gas by the gas compressor, using the harvested wind energy. The gas compression may be achieved by a linear motion of a gas tight piston, pulled by the tether. There may be a further step of utilizing hot compressed gas, produced by the gas compressor, for one of the following: energy storage, water desalination, water heating, buildings heating, running an electrical generator, shale oil extraction, oil recovery from oil sands, synthetic fuel production, hydrocarbons cracking, hydrocarbons steam reforming, iron ore melting, hydrogen production.

Another embodiment of the invention is a method of energy storage, comprising steps of: providing a tethered airborne wing; providing an energy storage medium; harvesting wind energy using the tethered airborne wing; converting the harvested wind energy into mechanical energy; converting the mechanical energy into internal energy of the storage medium. The storage medium may comprise or contain at least one of: compressed gas, condensed gas, heated liquid, frozen liquid, heated solid matter, molten solid matter and sorptive substance.

Another embodiment of the invention is a method of improving efficiency of a natural gas power plant, in which some of the mechanical energy for air compression prior to combustion is supplied by an airborne wind energy conversion system.

Another embodiment of the invention is a method of uninterrupted power production, comprising steps of: providing a first airborne wind energy conversion system, comprising an electrical generator; providing an energy storage at or near the ground; providing a second airborne wind energy conversion system, comprising a gas compressor; providing a third energy conversion system, comprising an electrical generator driven by the energy from the energy storage; utilizing the first airborne wind energy conversion system for power production; using the second airborne wind energy conversion system to charge the energy storage; establishing a minimum power output threshold; if the power production by the first wind energy conversion system drops below this threshold, utilizing the third energy conversion system additional power production.

Another embodiment of the invention is a device for converting wind energy into a storable form of energy, comprising: an airborne member, adapted to harvest wind energy; a tether, attaching the airborne member to the ground; a gas compressor at the ground level, coupled to the airborne member.

Another embodiment of the invention is a device for converting wind energy into electrical energy, comprising: an airborne member, adapted to harvest wind energy; a tether, attaching the airborne member to the ground; a gas piston at the ground level, coupled to the airborne member and adapted to compress air; a pneumatic motor, driven by the air, compressed with the gas piston; an electric generator, driven by the pneumatic motor.

Another embodiment of the invention is an energy storage device, comprising: an airborne member, adapted to harvest wind energy; a tether, attaching the airborne member to the ground; a water pump at the ground level, coupled to the airborne member; a low water reservoir and a high water reservoir; the water pump is adapted to deliver water from the low water reservoir to the high water reservoir.

Another embodiment of the invention is a device for converting wind energy into electrical energy, comprising: an airborne member, adapted to harvest wind energy; a tether, attaching the airborne member to the ground; a hydraulic piston at the ground level, coupled to the airborne; a hydraulic motor, driven by water pushed by the hydraulic piston; an electric generator, driven by the hydraulic motor.

Another embodiment of the invention is a device for converting wind power into electrical power, comprising steps of: harvesting the wind power with an airborne member; using the harvested power for linear motion of a piston in a gas cylinder; converting the pressure of the compressed gas in the hydraulic cylinder, into rotational motion of a rotor; converting the rotational motion of the rotor into electrical power.

Another embodiment of the invention is a method for converting wind power into electrical power, comprising steps of: harvesting the wind power with an airborne member; using the harvested power for linear motion of a piston or a plunger in a hydraulic cylinder; converting the motion of the liquid in the hydraulic cylinder, into rotational motion of a rotor; converting the rotational motion of the rotor into electrical power.

Another embodiment of the invention is a device and a method for producing compressed hot gas using wind energy, comprising: a tethered airborne member, harvesting wind energy; and a gas compressor at or near the ground level, coupled to the airborne member and driven by the harvested energy. The gas can be air, water vapors, CO₂, helium, argon and other.

The produced hot air and/or steam can be further used for multiple purposes, including energy storage, water desalination, water distillation, water heating, buildings heating, supplying high quality heat for an industrial process, supplying compressed air for an industrial process, supplying steam for an industrial process, running an electrical generator. Examples of industrial processes include shale oil extraction, oil recovery from oil sands, synthetic fuel production, hydrocarbons cracking, hydrocarbons steam reforming, iron ore melting, hydrogen production, CO₂ capture. The harvested energy may be transferred from the tethered airborne member by action of the unrolling tether, or by action of a motion transfer cable, distinct from the tether, coupled to the airborne member and coupled to a spool or a sheave at or near the ground level.

The air compressor can be of a conventional type or of a special construction. The device with the air compressor of the conventional type comprises a mechanism, converting linear motion of the tether or the cable into rotational motion of an axle, driving the air compressor. The air compressor of the special construction comprises an air cylinder with an air tight piston, driven by the tether or the cable. Advantageously, plurality of cylinders may be provided.

When the device is used for energy storage purposes, an energy storage medium is provided. The energy storage medium may contain or comprise some of: compressed gas, condensed gas, heated liquid, frozen liquid, heated solid matter, molten solid matter, sorptive substance or some combination of these types. The stored energy can take a form of sensitive heat (example: heated oil, heated molten salt or gravel), latent heat (example: phase changing materials, such as melting paraffin), other (example: compressed air).

The tethered airborne member can be a wing or a parachute. The airfoil can advantageously fly cross wind. Multiple airfoils may be provided.

Another embodiment of the invention is a method of using existing fossil fuel power plants, comprising steps of: i) when sufficient wind is present, producing compressed hot air using wind energy with a device, comprising: a tethered airborne member, harvesting wind energy; and an air compressor at or near the ground level, driven by the harvested energy; ii) sending the compressed hot air through the turbine of the power plant; iii) optionally, some fossil fuel may be burnt in the compressed hot air; iv) optionally, water may be mixed with the compressed hot air to produce vapor.

One more embodiment of the invention is a power plant, comprising: a gas turbine; an electrical generator, coupled to the gas turbine; an airborne member, such as a wing or a parachute; an air compressor, coupled to the airborne member; control means for making at least one of the following determinations: i) whether to drive the turbine from the wind energy or by burning fuel; ii) whether to burn any fuel in the hot compressed air before it impacts the turbine blades; iii) how much fuel to burn in the hot compressed air before it impacts the turbine blades.

One more embodiment of the invention is a wind power plant, comprising: a) a first AWECS, continuously converting wind power into electrical power; b) an energy storage; c) a second AWECS, converting wind energy into recoverable internal energy of matter, stored inside of the energy storage; d) a third energy conversion system, comprising an electrical generator, powered by the recoverable internal energy of matter; e) wherein a firm power capacity value P₀ below peak power of the first AWECS is predefined; and when the power output of the first AWECS drops below P₀, the third energy conversion system is operated to output additional power. With sufficient energy storage, this wind power plant provides at least P₀ power at any time. The first AWECS, the second AWECS and/or the third energy conversion system can share common parts. Each of the first AWECS, second AWECS and third energy conversion systems can comprise multiple individual energy conversion devices, separate and located at some distance one from another. The matter, used in the recoverable internal energy storage, may be some of: compressed gas, condensed gas, heated liquid, frozen liquid, heated solid matter, molten solid matter or some combination of these forms.

Another aspect of the invention is a device and a method for converting energy of linear motion of an elongated body into internal energy of hot compressed gas, comprising: at least one cylinder assembly, comprising a cylinder, a valve, a piston and a fastener, coupled to the piston and adapted to rapidly engage and disengage the elongated body; wherein the cylinder assembly is used to simultaneously compress and heat up the air in the cylinder and output the hot compressed air through the valve. The fastener can be mechanical (like a hook, a tooth, a pin or a hole), magnetic, Velcro, vacuum based, adhesive based, friction based etc. The gas can be air, water vapors, CO₂ and other.

Another aspect of the invention is a method of utilizing energy of wing, comprising steps of: harvesting energy of wind using AWECS; immediate converting the harvested wind energy into mechanical energy of pumping motion; immediate converting of the mechanical energy of the pumping motion into internal energy of matter. The internal energy of matter can be sensible heat, latent heat, gas pressure or other.

Another aspect of the invention is an energy storage system, comprising: a tethered airborne wing; a gas compressor, coupled to the tethered airborne wing; an energy storage medium; a heat exchanger, capable of transferring heat of the compressed gas to the storage medium; a heat engine, adapted to utilize heat from the storage medium; and an electrical generator, driven by the heat engine. The heat exchanger can be further adapted for gas pressure drop.

Another aspect of the invention is a device for converting wind energy into a storable form of energy, comprising an airborne member, such as a wing or a parachute; air compression means, mechanically coupled to the airborne member; and an energy storage medium; wherein the wind energy, harvested by the airborne member, is converted into the internal energy of hot compressed air before being stored in the storage medium. The storage medium can take a form of compressed gas, condensed gas, heated liquid, frozen liquid, heated solid material, molten solid material or combination of these forms. Means for recovery of the stored energy are provided.

Another aspect of the invention is a method of converting wind energy into a storable form of energy, in which an airborne member, such as a wing or a parachute, harvests wind energy; the harvested energy is used to heat and compress air in a vessel; the energy of the hot compressed air is stored in one or more of the following forms: compressed gas, condensed gas, heated liquid, frozen liquid, heated solid material, molten solid material or combination of these forms. The stored energy is recovered and converted into electrical energy, when required.

Another aspect of the invention is a device for converting wind energy into electrical energy, comprising an airborne member, such as a wing or a parachute air compression means, mechanically coupled to the airborne member; a turbine, at least partially driven by the compressed air from the cylinder; and an electrical generator, coupled to the turbine. An optional combustor can be provided to burn fuel in the compressed air.

Another aspect of the invention is a method of upgrading existing fossil fuel power plants, comprising steps of: providing an airborne member, such as a wing or a parachute; providing means for compressing air, coupled to the airborne member; harvesting wind energy with the airborne member and converting it into internal energy of hot compressed air; feeding the existing turbine of the power plant with the hot compressed air instead of or in addition to the gas or steam, obtained by burning the fossil fuel. If the existing turbine was of the gas turbine type, the hot compressed air can impact the turbine blades directly or after some fuel is burnt in it. If the existing turbine was of the steam turbine type, water can be mixed into the hot compressed air to produce steam.

Another aspect of the invention is a device for converting wind energy into electrical energy, comprising an airborne member, such as a wing or a parachute; a hydraulic cylinder, having a piston, mechanically coupled to the airborne member; a hydraulic motor, hydraulically connected to the cylinder; an electrical generator; where the rotor of the electrical generator is rotationally connected to the rotor of the hydraulic motor. The system can also comprise additional cylinders or pipes of smaller diameter and one or more valves. A control system can be provided. The control system can control the valves to provide pressure and/or impulse to the hydraulic motor on both back and forth motions of the piston. The embodiments can also comprise means to transfer mechanical energy, harvested by the airborne wing, to the piston in both its back and forth motions.

Another aspect of the invention is a method of converting wind power into electrical power, comprising steps of harvesting the wind power with an airborne member, such as a wing or a parachute; using the harvested power for linear motion of a piston in a hydraulic cylinder; converting the pressure and/or impulse in the hydraulic cylinder, into rotational motion of a rotor; converting the rotational motion of the rotor into electrical power. Optionally, conversion of the wind power into electrical power can be performed in both back and forth motions of the piston.

Another aspect of the invention is a device for pumping water using wind energy, comprising: an airborne member; a tether, coupled to the airborne member; a hydraulic cylinder with a piston or a plunger, the piston getting intermittently coupled to the tether; a water pump, operated by motion of the piston or plunger.

Another aspect of the invention is an energy storage device, in which wind energy is converted into potential energy of elevated water, using the device for pumping water, described immediately above. Another aspect of the invention is a wind farm with firm capacity, using this energy storage device.

Various objects, features, aspects, and advantages of the present invention will become more apparent from the following detailed description of preferred embodiments of the invention, along with the accompanying drawings in which like numerals represent like components.

The description uses prior patent applications by the inventor: PCT/US12/66331 (01-PCT), PCT/US12/67143 (02-PCT), PCT/US12/71582 (05-PCT), PCT/US13/30314 (06-PCT), PCT/US13/51419 (08-PCT).

All referenced patents, patent applications and other publications are incorporated herein by reference, except that in case of any conflicting term definitions or meanings the meaning or the definition of the term from this disclosure applies.

### BRIEF DESCRIPTION OF THE DRAWINGS

The accompanying drawings illustrate the invention. The illustrations omit details not necessary for understanding of the invention, or obvious to one skilled in the art, and show parts out of proportion for clarity. In such drawings:

FIG. 1 shows a perspective view of one embodiment of the invention.

FIG. 2 shows details of a pneumatic cylinder and a mechanism for engaging/disengaging it with the belt.

FIG. 3 shows a sample trajectory of a wing.

FIG. 4 shows an embodiment in which the converted energy is used to run a desalination plant.

FIG. 5 shows a wind farm with a firm capacity according to another aspect of the invention.

FIG. 6 shows details of another variant of a pneumatic cylinder with two valves.

FIG. 7 shows one embodiment of an energy storage system, utilizing separate heat and pressure storages.

FIG. 8 shows a system in which wind energy is used for heavy oil extraction.

FIG. 9 shows details of a double pneumatic cylinder.

FIG. 10 shows another embodiment of an energy storage system, utilizing only a heat storage.

FIG. 11 shows a perspective view of another embodiment, utilizing a tall cylinder with a heavy piston.

FIG. 12 shows a sectional view of the tall cylinder, the piston and a scheme of a gas turbine.

FIG. 13 shows a sectional view of the pneumatic cylinder, the piston and a heat storage.

FIG. 14 shows a sectional view of an embodiment with multi stage energy generation and storage.

FIG. 15 shows another embodiment, having a hydraulic cylinder, in the working phase

FIG. 16 shows some details of the same embodiment in the returning phase

FIG. 17 shows a perspective view of one embodiment of the invention.

FIG. 18 shows details of a hydraulic system and a mechanism for engaging/disengaging the hydraulic cylinder with the belt.

FIG. 19A shows a back view of the piston in the embodiment above.

FIG. 19B shows a side sectional view of the piston in the cylinder in the backstroke.

FIG. 20 shows an embodiment in which the short stroke piston is used to pump the water sectional view with schematic elements.

### DETAILED DESCRIPTION OF THE PREFERRED EMBODIMENTS

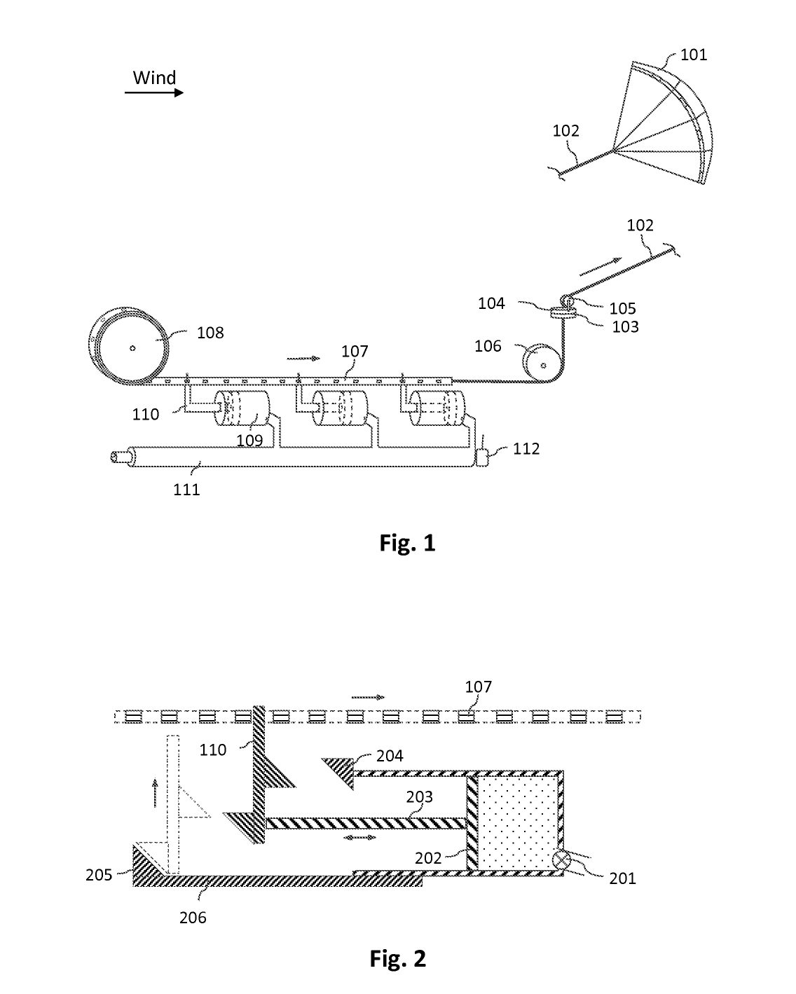

FIG. 1 shows one embodiment of the invention. It comprises an airborne wing 101, harvesting wind energy by moving cross wind. A tether 102 is attached to wing 101. Other elements of the construction, shown in FIG. 1 and described below, are installed on the ground. Particulars of attachment of the elements to the walls, ground and other supporting structures are not shown to avoid clutter. There is a ring 103, installed on a slightly elevated structure. Another ring 104 is installed on top of ring 103 on ball bearings and is capable of horizontal rotation to accommodate changes in the direction of the wind. A vertical pulley 105 is installed on ring 104. Tether 102 wraps around pulley 104 and drops inside of rings 103 and 104, so that it remains vertical no matter how ring 104 with pulley 105 rotate. Tether 102 goes around a vertical pulley 106, as shown in FIG. 1, so that it comes out horizontally. A perforated belt (or a chain) 107 is attached at the end of tether 102 and winds on/unwinds from a spool 108, which is placed at some distance from pulley 106. In the working phase that will be described below, wing 101 moves generally away from the ground installation, tether 102 moves as shown by an arrow, pulling belt 107, which unwinds from spool 108 and moves to the right. Three pneumatic cylinders 109 are provided on the ground near spool 108, their pistons are driven by pins 110, engaged by belt 107. The air is compressed and heated in cylinders 109 and the hot compressed air is pumped into a common vessel 111, from which it is consumed as needed. Vessel 111 can have a form of cylinder. A control system 112 is provided for automatic operation of the system.

FIG. 2 shows details of cylinder 109. There is a high pressure control valve 201 in the back wall of cylinder 109. Piston 202 is air tight, and is equipped with a piston rod 203. Piston rod 203 is attached to pin 110 in such way that pin 110 can glide vertically on piston rod 203. A triangular flange 204 is attached to the upper side of cylinder 109, and another triangular flange 205 is provided on the end of a beam 206, attached to the lower side of cylinder 109. The cylinder cycle begins when pin 110 is engaged with belt 107, moving to the right. Piston 202 moves from its left most position to the right, adiabatically compressing air in the cylinder. The air in the cylinder heats up in accordance with the laws of thermodynamics. When the pressure in the cylinder exceeds the pressure inside of vessel 111, valve 201 opens, and the continuing motion of piston 202 pushes most of the compressed air out of the cylinder into vessel 111 in an isobaric process. When piston 202 have almost reached the back wall of the cylinder, the upper flange on pin 110 meets flange 204, causing pin 110 to slide down and disengage from belt 107. Pressure of the remaining air in the cylinder pushes piston 202 back to the left. Valve 201 closes. As piston 202 moves to the left, outside air is allowed into the cylinder. When piston 202 have almost reached its left most position, the lower flange on pin 110 meets flange 205, causing pin 110 to slide up and engage belt 107. By that time, the cylinder is filled with the air at atmospheric pressure and ambient temperature, and a new cycle starts.

It should be noted, that the force, with which pin 110 acts on belt 107, varies very much over the cylinder cycle. The force grows from zero to the maximum value in the adiabatic phase of the forward stroke, then remains constant in the isobaric phase (which is much shorter than the adiabatic phase), then drops to 0 in the back stroke (which is shorter than forward stroke). Therefore, it is advantageous to employ multiple cylinders, with their cycles shifted in phase, in order to keep the force, acting on belt 107, approximately constant. For example, a system can use 5 cylinders, each having a cycle of 0.5 second, and the cycle of each cylinder is shifted 0.1 second from the cycle of the previous cylinder. This will also help to keep the pressure inside of vessel 111 approximately constant. Vessel 111 should also have volume, significantly larger than the volume of a single cylinder.

The whole device operates in cycles (which should be distinguished from the cylinder cycles; a device cycle is much longer than a cylinder cycle). Each device cycle consists of a working phase and a returning phase. The working phase starts when most of belt 107 is wound around spool 108, and wing 101 is at the closest position to the ground installation. Wing 101 flies cross wind in a controlled pattern, such as “figure eight”, using aerodynamic lift to pull tether 102. Tether 102 pulls belt 107, which unwinds from spool 108 and brings in motion pistons 202 of cylinders 109, thus heating and compressing air. In effect, the system harvests the energy of the wind and converts it into the internal energy of the air. In its upper part, tether 102 has some angle to the horizon, typically in the range 20°-40°. The typical tangential speed of tether 102 is ⅓ to ⅔ of the scalar value of the projection of the wind velocity on the upper tether part. Wing 101 is controlled in such way that the tension of tether 102 (and, consequently, of belt 107) does not change significantly over the working phase. Arrows in FIG. 1 show the direction of the motion of belt 107 and tether 102 in the working phase. The working phase ends when almost all belt 107 is unwound from spool 108. The returning phase starts. In the returning phase, belt 107 is raised above pins 110 of cylinders 109. An external electrical motor (not shown) rotates spool 108 in the opposite direction, winding belt 107 back on spool 108. These operations are performed under command of control system 112. Belt 107 pulls tether 102, which pulls wings 101 closer to the ground installation, toward its original position. In the end of the returning phase, control system 112 orders wing 101 to enter a stable “figure eight” trajectory. Then belt 107 is lowered and starts unwinding from spool 108, engaging pins 110 one after another with a proper phase shift, and a new working phase starts.

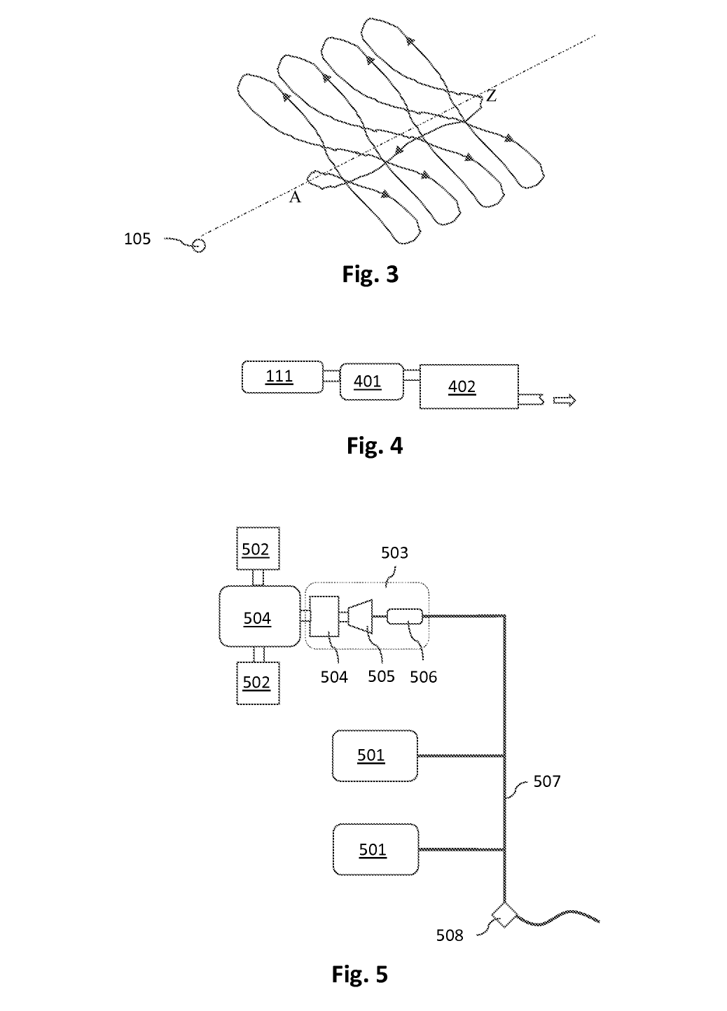

FIG. 3 shows an example of the wing trajectory. In the beginning of the working cycle, wing 101 is in point A. In the working phase wing 101 moves cross wind in figure eight trajectory, continuously increasing distance between itself and the ground installation. In the returning phase, wing 101 moves from point Z to point A. The distance between them is much shorter than the distance it covers in the working phase. Wing 101 is controlled to create minimum drag in the returning phase. Speed of tether roll in the returning phase can be larger than the speed of tether roll out in the working phase. Consequently, the returning phase can be much shorter than the working phase.

One advantage of the device, described above, is that it allows conversion energy of linear motion of a tether directly into internal energy of the compressed air, without an intermediate conversion into electrical energy, or even rotational motion. This allows performing energy conversion at much lower cost per kW and/or kWh. Sample system parameters:

Number of cylinders: 5; cylinder 109 diameter: 2 m; cylinder 109 length: 3 m; belt 107 speed (working phase): 6 m/s; belt 107 length: 120 m; device cycle: 25 s; working phase: 20 s; cylinder cycle: 0.5 s; vessel 111 max pressure: 60 bar; vessel 111 max temperature: 700° C.; tether 102 tension: 350 MN; peak power: 225 MW; average power: 150 MW

The device, described above, can be modified in multiple ways. For example, cylinders 109 can be placed both below and above belt 107. Belt 107 can be replaced with a rod, having teeth or holes for pins 110. Cylinders 109 can be placed in any direction from such rod, and spool 108 becomes unnecessary.

Alternatively, the device can comprise an AWECS, which converts power of the wind into rotation of an axle of a conventional air compressor, such as centrifugal compressor, vane compressor, reciprocating compressor or some other known compressor type. Multiple examples of AWECS, suitable for this embodiment, can be derived from PCT/US12/66331 or from another referenced publication by a person, skilled in the art.

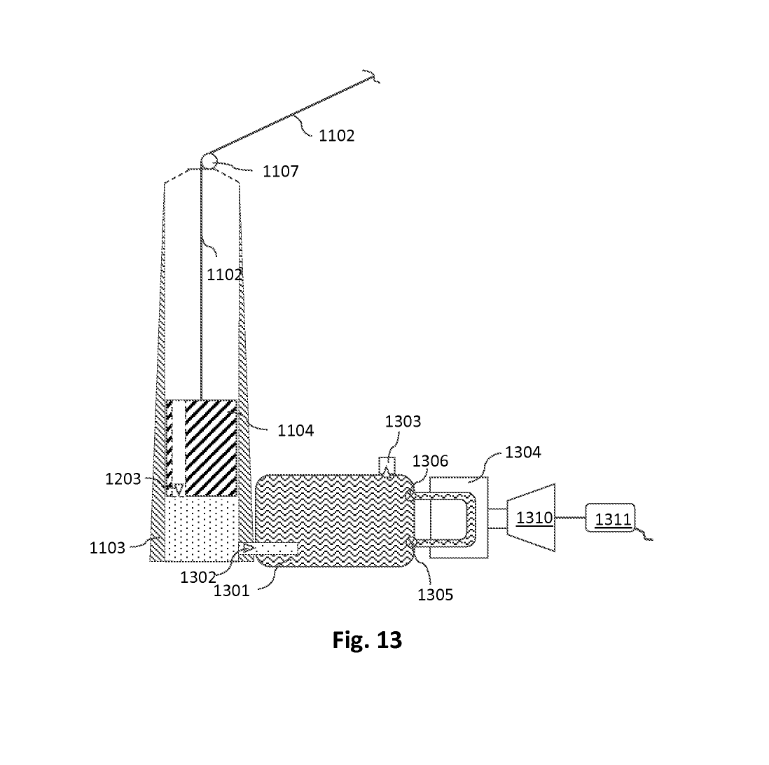

Hot compressed air, obtained from one of the devices, described above, can be used in multiple ways. One of them is to charge an energy storage system. The device from FIG. 13 can be used. Other suitable systems can be derived by combining this disclosure with PCT/US12/71582. Such energy storage system, used in conjunction with AWECS or conventional wind turbines, can be used to provide wind power plants with a firm capacity.

For example, a wind farm, connected to a grid, can comprise 50 AWECS from PCT/US12/66331, with nameplate (or peak) capacity Pₙ₁=10 MW each, producing electrical energy and outputting it directly to the grid. This capacity is achieved when the wind speed is Wₙ=15 m/s or more. Let us call these AWECS wind-to-electricity (W2E) type. Then, there are 20 AWECS described above, converting wind energy into the heat of molten salt, with the peak power capacity Pₙ₂=20 MW each. We will call these AWECS wind-to-storage type (W2S). There are also 10 molten salt reservoirs, sufficiently insulated, each reservoir is supplied by two W2S AWECS. The ground installations of these AWECS should be close one to their reservoir and one to another, so their wings fly at different altitudes to avoid collisions. For each molten salt reservoir, there is a boiler, producing overheated steam, a steam turbine and an electrical generator connected to it. We will call this energy conversion subsystem storage-to-electricity (S2E). For the firm capacity of 250 MW, the farm needs to use 10 electrical generators with the nominal output power Pₑ=25 MW. As long as the wind speed is above certain W₀, the W2E can provide at least the firm capacity to the grid. When the wind speed drops below W₀, S2E kick in, providing at least difference between the declared firm capacity and the power, generated by W2E. When the wind speed drops below the cut off speed or rises above maximum and W2E stop producing power, all the firm capacity is provided by S2E. The ability of the system to operate is dependent on sufficient capacity of the energy storage to provide the power difference in the times, when the wind power is not sufficient. For this end, it is important to observe, that wind power availability at the altitude is much higher, than near the surface. That moderates needs for the storage capacity. Further, W2E can be designed to have lower power drop when the wind speed decreases. Some further notes on this wind farm operation: a) when the energy storage is full (i.e., the temperature of the molten salt is at the maximum), S2E operates, even if the power, produced by W2E is above the firm capacity; b) W2S operates all time, when the wind allows (i.e., the wind speed is between the predefined minimum (cut off) and the maximum (near danger)); c) when the energy storage is not full, S2E operates only if the power, generated by W2E drops below the firm capacity, or if there is external demand for additional power;

It useful to notice, that the peak power, generated by this system, equals to the sum of W2E and S2E nominal powers (750 MW in this example). The firm power is 250 MW, supplied even when there is no wind. Thus, this system is on par with nuclear and fossil fuel plants in its ability to provide a firm capacity and a base load capacity. This system has an additional ability to provide dispatchable electrical power. Further, this wind farm can output low temperature heat in the form of hot water, serving as a combined heat and power station.

FIG. 5 shows a wind farm according to this aspect of the invention. It comprises two W2E AWECS 501, directly connected to an electrical cable 507, two W2S AWECS 502, connected by hot air pipes to a molten salt energy storage 504, an S2E 503, comprising a boiler 504, a turbine 505 and a conventional electrical generator 506, connected to electrical cable 507. Cable 507 connects to a transformer 508 that connects the wind farm to the grid.

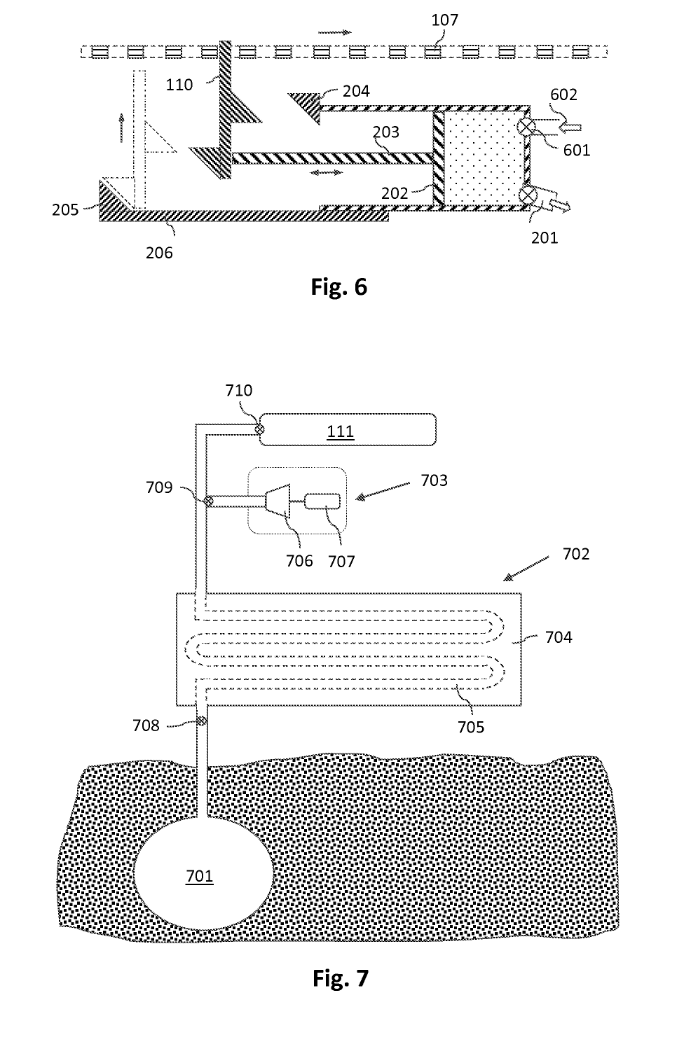

FIG. 6 shows a variation of air piston from FIG. 2. In it, there is another opening in the back wall of cylinder 109, connected to an air tube 602 and a directional control valve 601 in it. In the forward stroke valve 601 is closed. In the back stroke valve 601 opens, an external compressor (not shown) creates a moderate air pressure in tube 602. The moderately compressed air from the external compressor enters cylinder 109 through tube 602, pushing piston 202 to the left. Thus, at the start of the forward stroke cylinder 109 is filled with moderately compressed and slightly heated air. This allows for more efficient compression. The moderate pressure, created by the external compressor, can be equal to 10% of the maximum pressure in cylinder 109. For example, if maximum pressure in cylinder 109 is 60 bar, while the moderate pressure in tube 602 is 6 bar. The external compressor can be driven mechanically from belt 107 or by external energy source.

FIG. 7 shows a possible variation of the energy storage used in some embodiments of the invention. It comprises compressed air vessel 111, which was described above as a part of the device in FIG. 1. There is an underground cavity 701, a heat storage 702 and an air driven turbo-generator 703. Heat storage 702 can comprise steel air pipes 705 in a solid block 704, made of high temperature concrete, thermally insulated from the environment. Alternatively, a vessel with molten salt, oil or phase changing materials can be utilized instead of concrete block 704. Turbo-generator 703 comprises at least one (and possibly more than one) turbo-expander 706 and an electrical generator 707, having a rotor, rotationally connected to the turbine rotor of turbo-expander 706. Valves 708, 709 and 710 are provided as shown in FIG. 7.

The system works in one of three modes: charging, discharging and direct one. The charging mode is utilized when there is sufficient wind and the air in cavity 701 is under less than the maximum pressure and there is no external need for immediate power output. In the charging mode valves 708 and 710 are open and valve 709 is closed. Hot compressed air from vessel 111 passes through pipes 705 of thermal storage 702, giving away some of its internal energy to the concrete and cooling down. The compressed air after thermal storage 702 is stored in cavity 701. The discharging mode is utilized when there is no wind and there is significant air pressure in cavity 701. In the discharging mode valves 708 and 709 are open and valve 710 is closed. The cold air from cavity 701 passes through pipes 705 of thermal storage 702, warms up and gives its energy to the turbine rotor of turbo-expander 706, thus rotating the rotor of electrical generator 707, which produces electrical energy. The direct mode is utilized when there is sufficient wind and either the air in cavity 701 is under the maximum pressure or there is external need for immediate power output. In the direct mode valves 709 and 710 are open and valve 708 is closed. Hot compressed air from vessel 111 enters turbo-expander 706 directly, causing electrical generator 707 to produce electrical energy.

This embodiment has a benefit that it allows to convert, store and retrieve energy of the wind directly, without intermediate conversion into electricity and without utilization of fossil fuels. Thus, the input energy is almost free. This capability makes the device economically attractive even if it has very low system effectiveness measure (like below 20% in the charging-discharging cycle). This embodiment also allows producing electrical power for most of the time, when the energy storage is fully charged and sufficient wind is present. Multiple thermal storages with different heat storage medium and different maximum temperatures can be provided serially in order to utilize the heat of the air more efficiently. The charging and the direct modes can occur in the same time: valve 710 is open, valves 708 and 709 are open at least partially, and some of the compressed air from vessel 111 is used for immediate energy production and some of the compressed air is used to charge the storage.

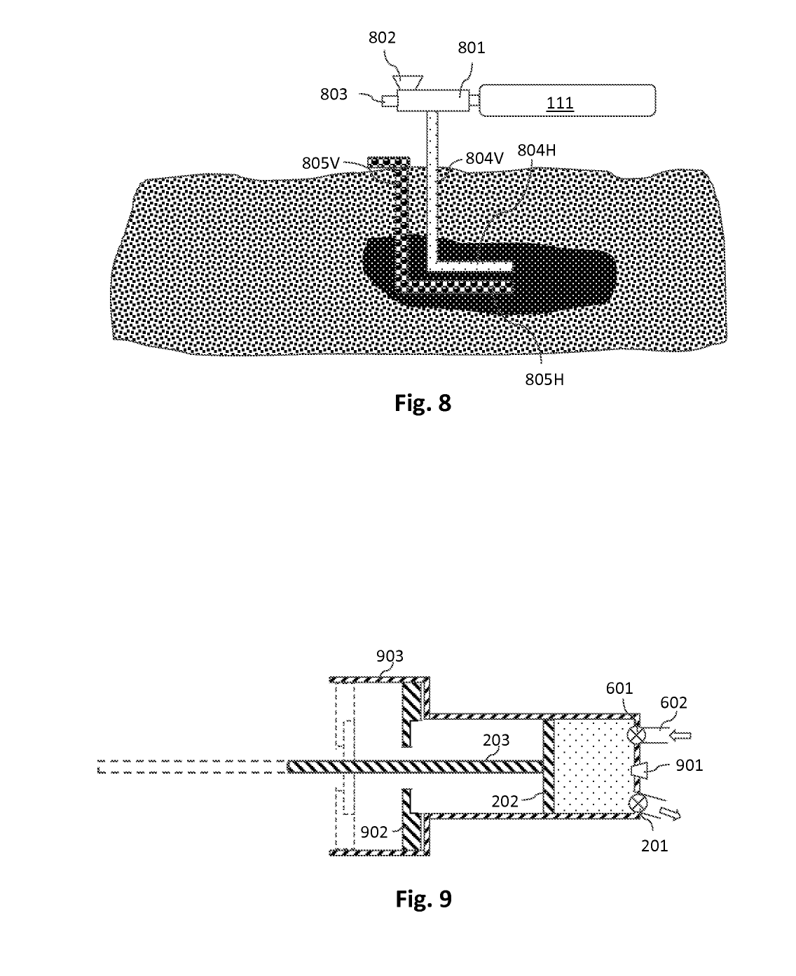

FIG. 8 shows an embodiment, in which an airborne wind energy conversion system is used for extracting oil from oil sands. It is based on the steam assisted gravity drainage, in which wind energy is used to generate high pressure steam. In this embodiment, the water continuously enters a heat exchanger 801 through a water tube 802. Hot air from vessel 111 heats up and evaporates the water inside heat exchanger 801, and exits through an exit pipe 803. Superheated steam out of heat exchanger 801 is sent through a vertical steam well 804V and horizontal steam well 804H into the bitumen or heavy oil formation. The liquid oil is pumped out through oil wells 805V and 805H. The compressed warm air from pipe 803 can be used for heating and other energy needs of the plant, such as heavy oil upgrade. Thus, the airborne wind energy conversion system takes place of fossil fuels or electrical energy as a source of heat and compressed gas (steam in this example) in an industrial process, saving fossil fuels and reducing pollution.

In an alternative arrangement, superheated steam can be produced inside of cylinders 109. In one such arrangement, saturated steam at temperatures 100-200° C. and pressures 1-10 bars is injected into cylinder 109 instead of the air in the back stroke. In the forward stroke, it is compressed to 50-500 bars and temperatures 400-800° C. Additional water can be continuously injected into cylinder 109 in the forward stroke. It should be noted that at the temperatures above 380° C. and pressures above 220 bars distinction between water and steam disappears, and water becomes a supercritical fluid. It is compressible and it can achieve relatively high density, accumulating large amount of energy. Thus, a large part of the forward stroke can be advantageously performed at constant pressure and temperature by injecting water into cylinder 109 at a constant rate, at which all mechanical energy, supplied by motion of piston 202 in a unit of time, is used to heat the water, injected in the same unit of time. This allows using smaller number of cylinders 109 in the system and lower material usage for the walls of cylinders 109. The saturated steam, injected into cylinder 109 in the back stroke, can be obtained by heating water using low quality (waste) heat from the system, or by diverting some of the superheated steam from vessel 111. The initial steam to start the process can be produced in an external boiler or inside cylinders 109, operating on air with water injection. The device and the method, described above, can be used in a system, producing “synthetic” fuels. One class of methods for production of “synthetic” fuels is Fischer-Tropsch process. Using natural gas, consisting mostly of methane, as the feedstock, this process involves the following reaction in the first step: CH₄+H₂O→CO+3H₂

This reaction is well known as steam reforming and it requires large amount of steam and energy. Both the steam and the energy can be supplied from vessel 111 of the device, described above.

The reaction is performed in a methane reformer. The hydrogen is sometimes removed and used for other purposes, possibly after water-gas shift reaction. A mix of CO and H₂ (known as syngas), is used to obtain liquid hydrocarbons in the following reaction:

(2n+1)H₂+nCO→CₙH₍₂ₙ₊₂₎+nH₂O(n>1)

It should be noticed, that operation of the device from FIG. 1 allows to achieve higher gas temperatures than are possible by burning fossil fuels in the air. This can be used for industrial application of reactions, that are currently performed only in scientific labs. One example is producing hydrogen by thermal decomposition of water. The device from FIG. 1 and FIG. 6 or FIG. 9 is used to produce steam at 2,300-2,700° C. Vessel 111 can be made in the form of a vertical cylinder. Hydrogen is removed at the high end of the cylinder. Vessel 111 and cylinder 109 can be made of tungsten with boron nitride or zirconia coating in this embodiment. The compression should be performed in two or more stages, where the saturated steam is produced and heated to 600-800° C. in the first stage and then injected in the back stroke into the second stage cylinder, where it is further compressed and heated to the required temperature.

Another option is production of hydrogen from water through recently discovered zinc/zinc oxide cycle at the temperature around 2,000° C. In such system the above described device is used to produce steam to above 2,000° C. The superheated steam is applied to zinc oxide, causing its decomposition into vaporized zinc and oxygen: 2ZnO->2Zn+O₂. The oxygen is removed, then the mix of zinc vapor and steam is cooled down to 800-900° C. and reacts as follows: Zn+H₂O->ZnO+H₂. At this point the hydrogen is removed.

For higher temperatures and/or pressures, cylinder 109 can be replaced by a multi-cylinder assembly, shown in FIG. 9. It comprises a cylinder of larger diameter with walls 903 and a cylinder of smaller diameter. The piston is also compound, having a larger diameter piston part 902 and a smaller diameter piston 202. FIG. 9 also shows an optional water injector 901. The dashed lines show the position of the compound piston in the beginning of the forward stroke. Smaller piston 202 is temporary attached to larger piston 902. When the compound piston reaches extreme right position, smaller piston 202 disengages and continues forward motion. In the back stroke, smaller piston 202 moves to the left until it contacts larger piston 902, to which it attaches itself, and the compound piston continues its motion until it reaches its extremely left position. Such multi-cylinder assembly has an advantage that the larger cylinder is subject to lower pressure and temperature, and it can be made with less material and with the less expensive material, than the smaller cylinder. Also, such assembly will provide more uniform resistance to belt 107.

Besides energy storage systems and methods, disclosed in PCT/US12/71582, some other energy storage systems, described in the referenced publications, can be used.

Another aspect of the invention is a water desalination plant, utilizing the device from FIG. 1 for saltwater heating. FIG. 4 shows a water desalination plant, in which the hot air from vessel 111 enters heat exchanger 401, where it heats seawater to 120° C. The heated seawater enters a multistage flash desalinator 402, where some of it evaporates and then condenses. The condensed water exits as shown by the arrow.

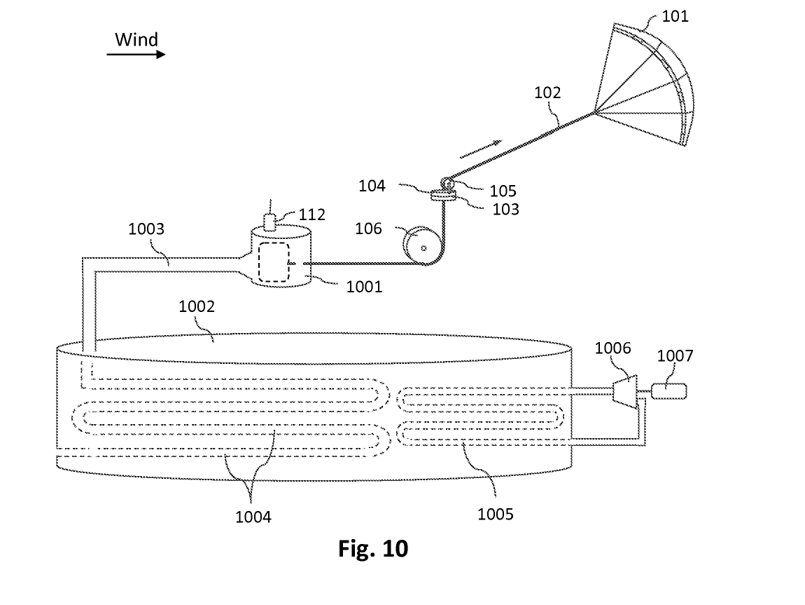

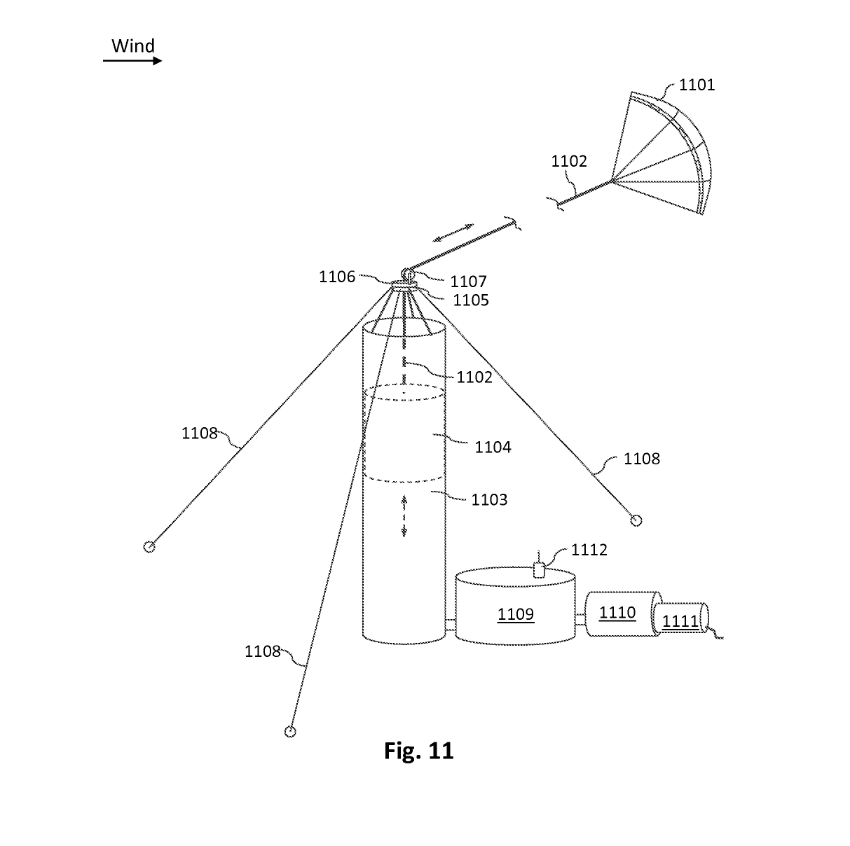

FIG. 10 shows another embodiment of an energy storage system, comprising airborne wing 101 and elements numbered 102 to 106 and 112 from FIG. 1. There is also an air compressor 1001 and a tank 1002 with a molten salt mixture, which may contain two or more salts of the following: sodium nitrate, potassium nitrate and calcium nitrate. Compressor 1001 compresses and heats up air, then sends it through an external pipe 1003 and through a submerged pipe 1004 inside of tank 1002. Pipe 1004 serves two functions: ensuring air pressure drop and heat exchange. To ensure air pressure drop, submerged pipe 1004 can be made of cast iron with rough internal surface, or of a steel tube with circular threading or wire meshes, placed inside of submerged pipe 1004. Because of the pressure drop, most of the internal energy of compressed air is converted to heat and transferred to the molten salt. The air exits submerged pipe 1004 with pressure, only slightly above atmospheric pressure, and temperature, only slightly above the melting point of the salt mixture. When electrical energy is required (in response to electricity demand peak or electricity production drop by some of renewable power plants), water is passed through water heat exchanger 1105, where it becomes steam, which rotates the rotor of a steam turbine 1006, which rotates the rotor of an electrical generator 1107. This embodiment allows to avoid storing any gases under pressure. Oil and other liquids can be used instead of the molten salt. Another gas, such as argon, can be used instead of air, in which case the system should be closed in regards to that gas. In a variation of this system, a bulk of gravel inside of a silo is used as a heat storage medium instead of tank 1002. In this variation submerged pipe 1004 is not required. External pipe releases hot compressed air at the bottom of the gravel silo, and both pressure drop and heat exchange occur in the gravel volume. The air exits via holes at the silo top. The size of the silo and of the gravel grains are selected to ensure efficient pressure drop and heat exchange.

FIG. 11 shows another embodiment of the invention. It comprises an airborne wing 1101, harvesting wind energy by moving cross wind. A tether 1102 is attached to wing 1101. A tall pneumatic cylinder 1103 is installed on the ground. A heavy piston 1104 is placed inside of cylinder 1103 air-tight. Piston 1104 can move up and down. A ring 1105 is installed on top of cylinder 1103, a horizontal platform 1106 is installed on ring 1105 on ball bearings and is capable of horizontal rotation. A vertical pulley 1107 is installed on rotating platform 1106. Tether 1102 wraps around pulley 1107, goes inside of cylinder 1103 and is attached in the center at the top of piston 1104. The operation of that part of the system is cyclical. Each cycle consists of two phases: upstroke and downstroke. In the upstroke, wing 1101, flying in figure eight trajectory, harvests wind energy and pulls tether 1102, raising piston 1104. Multiple guy wires 1108 hold ring 1105, resisting horizontal component of the large force, with which tether 1102 acts on pulley 1107. Additional guy wires can be used to support cylinder 103, but are not shown. In the downstroke, piston 1104 free falls inside of cylinder 1103, compressing the air below it. When the air pressure reaches a pre-defined value, compressed air is let into a large air chamber 1109, connected to cylinder 1103 near the bottom. The compressed air from chamber 1109 is used to continuously rotate a turbine 1110, which rotates the rotor of a generator 1111, which generates electrical energy, which is sent to the grid or other consumers. A control system 1112 is provided to automatically control motion of wing 1101, switch between the phases and supervise other aspects of the system operation. Wing 1101 is controlled to create minimal resistance air resistance and exert very small force on tether 1102 in the downstroke.

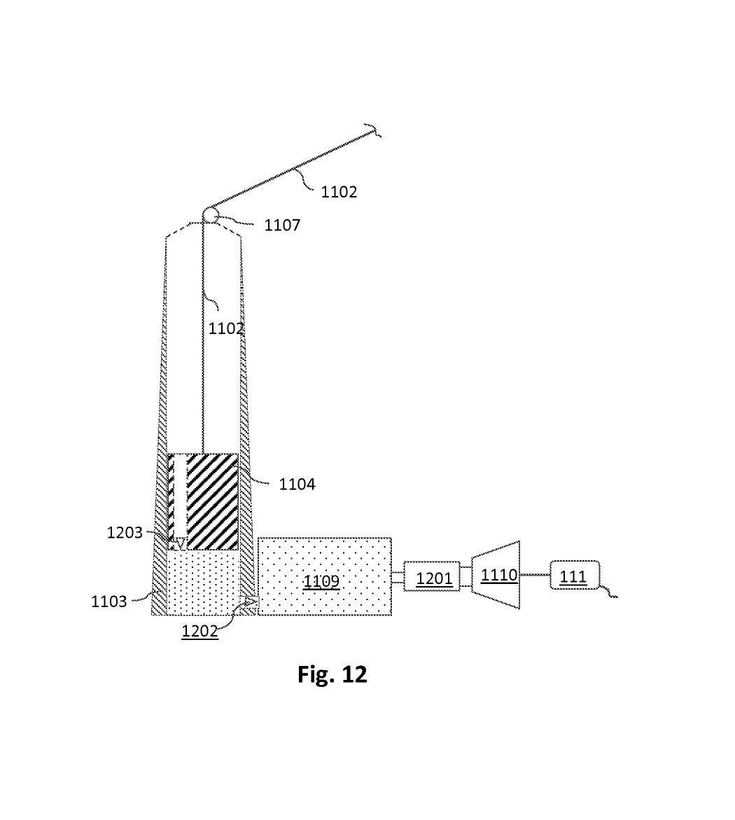

FIG. 12 shows a vertical sectional view of some system components with additional details. These include an optional combustor 1201 between chamber 1109 and turbine 1110, a pilot controlled check valve 1202 between cylinder 1103 and chamber 1109 and a simple check valve 1203 in piston 1104. Valve 1202 is opened by control system 1112 in the downstroke, when the air pressure under piston 1104 reaches the pre-defined value (which is higher than the pressure in chamber 1109). Valve 1203 opens in the upstroke, allowing outside air into the lower part of cylinder 1103.

The upstroke starts when piston 1104 is near the bottom of cylinder 1103. Wing 1101 flies cross wind in a controlled pattern, such as “figure eight”, using aerodynamic lift to pull tether 1102. Tether 1102 pulls piston 1104 up. In its upper part (above pulley 1107), tether 1102 has some angle to the horizon, such as 20°-40°. In accordance with Loyd, the preferred tangential speed of tether 1102 is one third of the scalar value of the projection of the wind velocity on the upper tether part. This is also the speed of upward motion of piston 1104. After piston 1104 almost reaches the top of cylinder 1103, the downstroke starts. Control system 1112 decreases angle of attack of wing 1103 in such a way, as to almost eliminate lift force (some lift can remain to keep the wing form). Piston 1104 free falls in cylinder 1103, compressing and heating the air in the lower part of the cylinder. It should be noted, that the pressure and the temperature in the lowest part of cylinder 1103 can reach values, similar to those in a gas turbine, depending on the system parameters. Therefore, the lower sections of the cylinder walls should be constructed to resist significant internal pressure and heat. This is not required from the upper parts of the cylinder walls, which need to resist mostly vertical compression forces, acting in the upstroke. In a typical system, the travel of piston 1104 is 100 m, piston speed in upstroke is 4-8 m/s, depending on the wind, and the upstroke time is 12-25 seconds. Downstroke time is about 6 seconds, including less than 2 seconds of discharge of compressed air from the bottom of cylinder 1103 into chamber 1109. Chamber 1109 should be sufficiently large to ensure approximately constant air pressure between discharges, despite constant air flow toward turbine 1110. Wing 1101 should provide constant force, equal to the weight of piston 1104, for most part of the upstroke. It is achieved by changing the angle of attack when the wind speed changes. Platform 1106 on the top rotates to accommodate changes in the wind direction. Piston 1104 stops slightly above the cylinder's bottom, held by the air pressure. Obviously, piston 1104 should be reasonably air tight in cylinder 1103, possibly utilizing piston rings or skirts. Cylinder 1103 can be made of steel or concrete, possibly with silica brick internal coating on the bottom.

This system can utilize many components of existing gas turbines, while using wind energy instead of the natural gas. When the wind becomes weak, frequency of the working cycles decreases, and the pressure in chamber 1109 drops. Then, the system uses combustor 1201 to burn some natural gas to increase pressure of the gas, hitting the turbine. If the wind ceases completely, the system can work as a conventional gas turbine, if it is equipped with a compressor.

One advantage of the described embodiment is its ability to economically convert the wind energy into electrical energy. Another aspect and advantage is that it can be used to upgrade existing gas or coal power station to work without fuel for most time. Another aspect and advantage is a combined wind/fossil fuel plant that can generate electrical energy from the wind, when there is sufficient wind, or from the fossil fuels, when there is no sufficient wind, or from both sources, if the wind speed falls below of what is required for full power operation. The following is an example of the described system. It assumes purely wind operation, no fuel burning. The piston is made mostly of iron. The cylinder walls are made of concrete. The dimensions are approximate.

Average Output Power: 500 MW; upstroke mechanical power: 1,333 MW; cylinder height: 150 m; cylinder diameter: 10 m; cylinder walls thickness over most of cylinder: 8 cm; piston mass: 27,200 tons; piston height: 44 m; piston travel: 100 m; wind speed: 17 m/s; tether angle to horizon: 30°; wings, lift coefficient: 1.5; wings and tether, drag coefficient: 0.1; wings area: 12,000 sq. m (2 wings, each wing has 300 m span, 20 m chord).

FIG. 13 shows another embodiment of the invention, which is an energy storage system. Wing 1101, cylinder 1103, piston 1104 and many other parts are similar to those described above. An additional part is an energy storage itself, which can take form of a tank 1301 with a molten salt. When there is sufficient wind, the system charges the energy storage: at each cycle, hot compressed air is discharged into tank 1301 through a valve 1302, heating the molten salt to 500-550° C. The air leaves the tank through an opening 1303 and retains some useable energy, that can be converted into electricity or used for heating. The system further includes usual arrangements for converting energy, stored in the form of heat, into electrical energy, such as: a heat exchanger 1304, a steam turbine 1310 and an electrical generator 1311. When it is desirable to convert the stored energy into electricity, control system 1112 opens valves 305 and 1306 and lets the molten salt into heat exchanger 1304, where it turns water into steam, which brings into motion turbine 1310, causing generator 1311 to produce electricity.

The system from FIG. 13 can be deployed in a wind farm together with wind turbines and other wind energy conversion devices, including the one, depicted in FIG. 11. When there is sufficient wind, it charges the energy storage. When there is no sufficient wind, it uses the stored energy to produce electricity. Thus, the wind farm will be able to provide guaranteed power output, not depending on the wind. One advantage of the embodiment in FIG. 13 is its ability to convert wind energy, harvested by an airborne wing directly into storable energy in the form of heat, compressed air or changed state of matter, without going through a step of electrical energy generation. Further, a single cylinder 1103 can be connected to both chamber 1109 with turbine 1110 and generator 1111, and tank 1301 with its turbine 1310 and generator 1111. When there is a plenty of wind, some of the compressed air from cylinder 1103 is sent to chamber 1109 to immediately produce electricity, and some of the compressed air is sent to tank 1301. When there is less wind, the compressed air from cylinder 1103 is sent only to chamber 1109 for immediate production of electricity. When there is even less wind, or no wind at all, the heat from tank 1301 is used to produce electrical energy. The energy storage and generation means according to the invention can be combined in more ways. For example, generator 1111 and generator 1311 can be the same. Turbine 1310 and turbine 1110 can be the same.

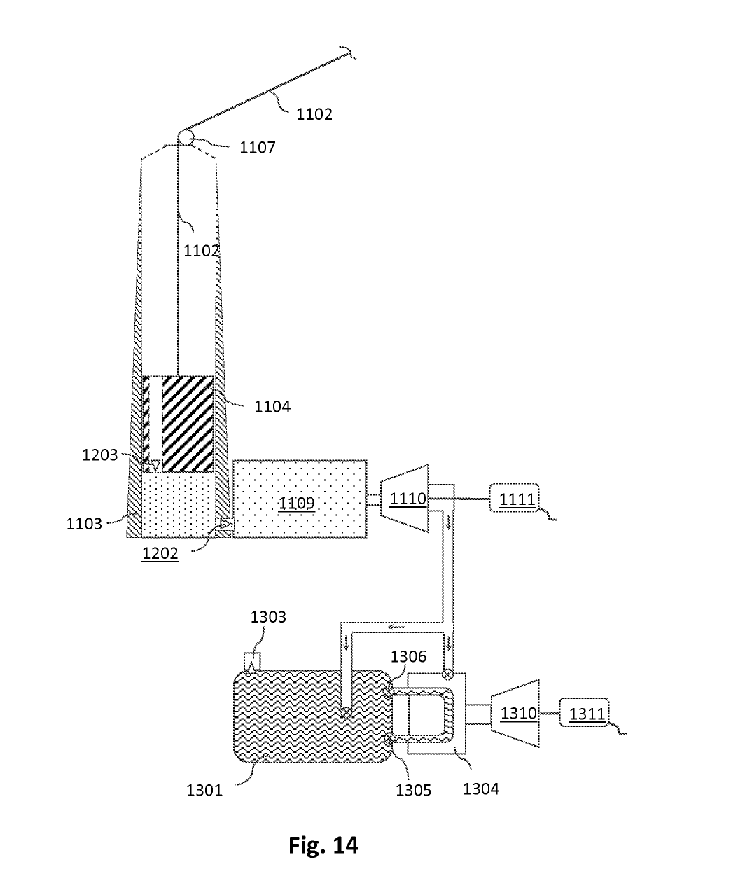

Alternatively, the generation and storage means can be combined into multi-stage turbine, where tank 1301 and turbine 1310 serve as the second stage for turbine 1110, as shown in FIG. 14. In this arrangement, the hot compressed air from cylinder 1103 goes into chamber 1109, then rotates turbine 1110. This air exits turbine 1110, retaining significant energy, and enters either tank 1301 or heat exchanger 1304. In heat exchanger 1304 it vaporizes the water and creates steam that rotates turbine 1310. When there is no wind and piston 1104 in cylinder 1103 is inactive, turbine 1310 works from the heat, accumulated in tank 1301.

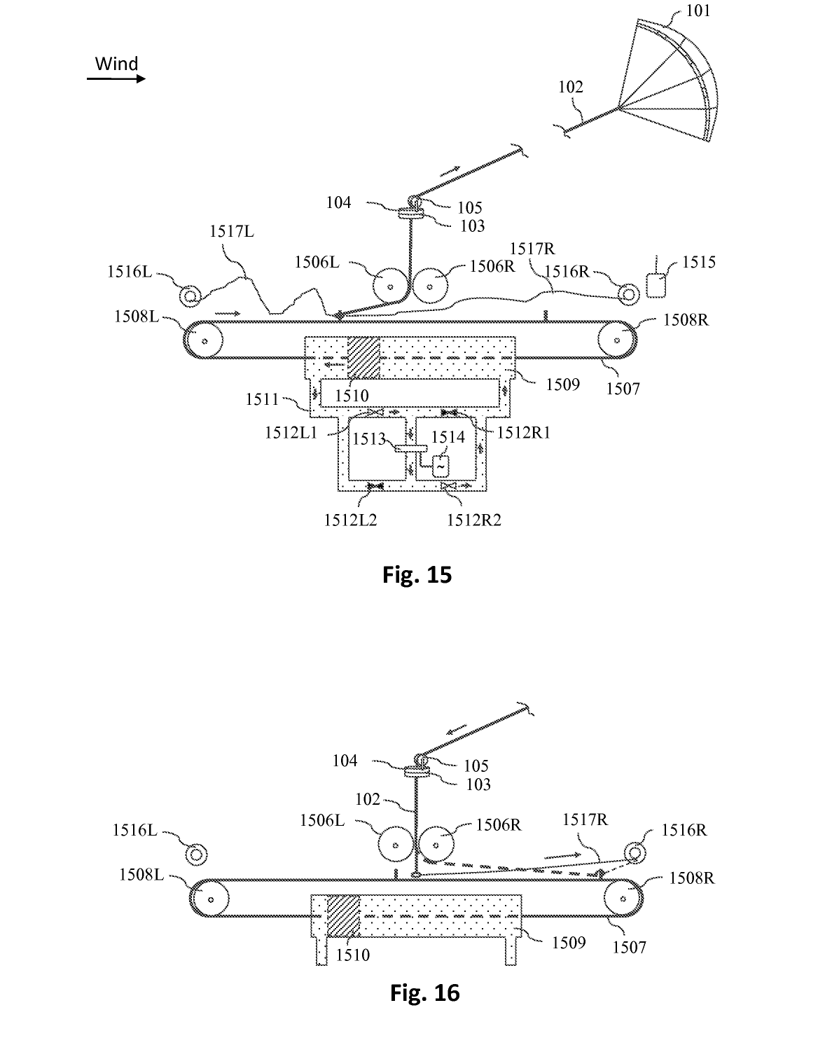

FIG. 15 shows one more embodiment of the invention. It comprises airborne wing 101, harvesting wind energy (or power) by moving cross wind. Tether 102 is attached to wing 101. Other elements of the construction, shown in FIG. 15 and described below, are installed on the ground. Particulars of attachment of the elements to the walls, ground and other supporting structures are not shown to avoid clutter. There is ring 103, installed on a slightly elevated structure. Another ring 104 is installed on ring 103 on ball bearings and is capable of horizontal rotation to accommodate changes in direction of the wind. Vertical pulley 105 is installed on ring 104. Tether 102 wraps around pulley 104 and drops inside of rings 103 and 104, so that it remains vertical no matter how ring 104 with pulley 105 rotate. There is a long hydraulic cylinder 1509 with a piston 1510 placed tightly inside of it. Looped cable 1507 is wrapped around pulleys 1508L and 1508R, passes through the ends of cylinder 1509 and is attached to the ends of piston 1510. Passage of cable in the ends of cylinder 1509 is made properly liquid tight. Two pulleys 1506L and 1506R are provided in contact with tether 102 below ring 103. At any time, tether 102 goes around one of these pulleys (1506L in FIG. 15) and is temporary attached to looped cable 1507. The system operates in cycles, each cycle consists of two symmetrical half-cycles, each half-cycle consists of the working and the returning phases. FIG. 15 shows the system in the working phase of the left half-cycle. Wing 101 pulls tether 102, tether 102 pulls looped cable 1507, looped cable 1507 pulls piston 1510 inside cylinder 1509, as shown by the thin arrows. A system of hydraulic pipes 1511 is connected to cylinder 1509 near its ends. Valves 1512L1, 1512L2, 1512R1, 1512R2 are placed in the pipes, as shown in FIG. 15. In the left half-cycle, valves 1512L1 and 1512R2 are open, valves 1512L2 and 1512R1 are closed. In the right half cycle, it is other way around. Short arrows show motion of the working liquid in the left half cycle. Pressure and/or impulse of the liquid acts on hydraulic motor 1513, which rotates the rotor of an electrical generator 1514. Electrical generator 1514 generates electrical energy. A control system 1515 is provided to ensure operation of the system. FIG. 1 also shows a pair of motorized winches 1516L and 1516R, pulling lines 1517L and 1517R, accordingly, use of which will be explained below. Thus, the wind power is converted into electrical power.

FIG. 16 shows relevant details from FIG. 15 and demonstrates operation of ground mechanisms in the returning phase and in time of switch between the half-cycles. In FIG. 16, piston 1510 has reached its extreme left position. In the beginning of the returning phase, tether 102 is detached from looped cable 1507. A line 1517R is attached to the end of tether 102. Motorized winch 1516R pulls this line, thus pulling in tether 102 and bringing its end to the right. In the end of the returning phase, the end of tether 102 is getting attached to looped cable 1507 on the right (the attachment points on cable 1507 are shown as small vertical lines on FIG. 15 and FIG. 16). Positions of tether 102 and line 1517R in the end of the returning phase are shown in dashed lines. The working phase of the next (right) half-cycle starts. Right half-cycle is symmetrical to the left half-cycle. Thus, the energy is transferred to hydraulic motor 1513 and electrical generator 1514 continuously, except for the short returning phases. The system can be engineered to make returning phases to take less than 10% of the total time and less than 1-2 seconds each time. Flywheels or other very short term energy storages can be used to ensure smooth energy generation in these times. The system can achieve 1,500-1,800 RPM on the rotor of hydraulic motor 1513, necessary for most electrical generators, eliminating need in a gearbox. This system allows using wing 101, hydraulic motor 1513 and generator 1514 with maximum efficiency. Preferably, tether roll out speed is ⅓-⅔ of the scalar of the projection of the wind velocity to the tether line. Preferably, a high speed hydraulic motor 1513 is used, such as a gear motor or vane motor. Machine oil can be used as the working liquid in the hydraulic subsystem. The advantage of this system is ability to economically convert the wind energy into electrical energy. The following are parameters of an example of the described system:

Cylinder 109 length: 50 m; cylinder 109 diameter: 1 m; working pressure in cylinder 109: 4000 psi; wind speed: 17 m/s; tether roll out speed: 5 m/s; tether angle to horizon: 30°; wing, lift coefficient: 1.5; wing and tether, drag coefficient: 0.1; wing area: 1,000 sq. m (100 m×10 m); half-cycle time: 11 seconds; conversion effectiveness: 80%; average output power: 80 MW

Control systems 112 and/or 1112 comprise at least one microprocessor, multiple sensors and actuators. They can be distributed, with a part of it being carried by wing 101 or 1101. Sensors can include day and night cameras, wing GPS, meters of pressure and temperature in cylinder 109 or 1103, wing speed meter, accelerometer, anemometer and more.

Wings 101 and/or 1101 can be of flexible or rigid construction, with appropriate control surfaces and actuators. A kite or a glider can be used as wing 101 and/or wing 1101, with addition of an appropriate control surfaces and actuators. Tether 102 and/or 1102 can be manufactured from ultra high molecular weight polyethylene fibers, aramids, para-aramids or another strong fiber. Belt 107 can be made of aramids, para-aramids, high or ultra high molecular weight polyethylene fibers and other sufficiently strong and flexible materials. A system of two or more wings can be used instead of one wing. Additional details on wings, systems of wings, tethers, wing trajectories and control can be found in the referenced publications. Optionally, aspects of wing construction, control and trajectory can be taken from U.S. Pat. Nos. 7,504,741 & 7,546,813 by Wrage et al and other referenced publications. The embodiments of the invention can be used on land or offshore.

Piston 1104 can be constructed from a thin walled steel tube, closed and covered with silica bricks on the bottom, and filled with inexpensive iron ingots. Iron ingots can be inserted on-site. Further, piston 1104 can consist of two or more shorter pistons, stacked upon each other. When the wind gets weaker, one or more shorter pistons can be left on the bottom of cylinder 1103 below valve 1202, decreasing the weight, that wing 1101 has to raise. When the wind gets stronger, these shorter pistons are automatically re-attached to piston 1104.

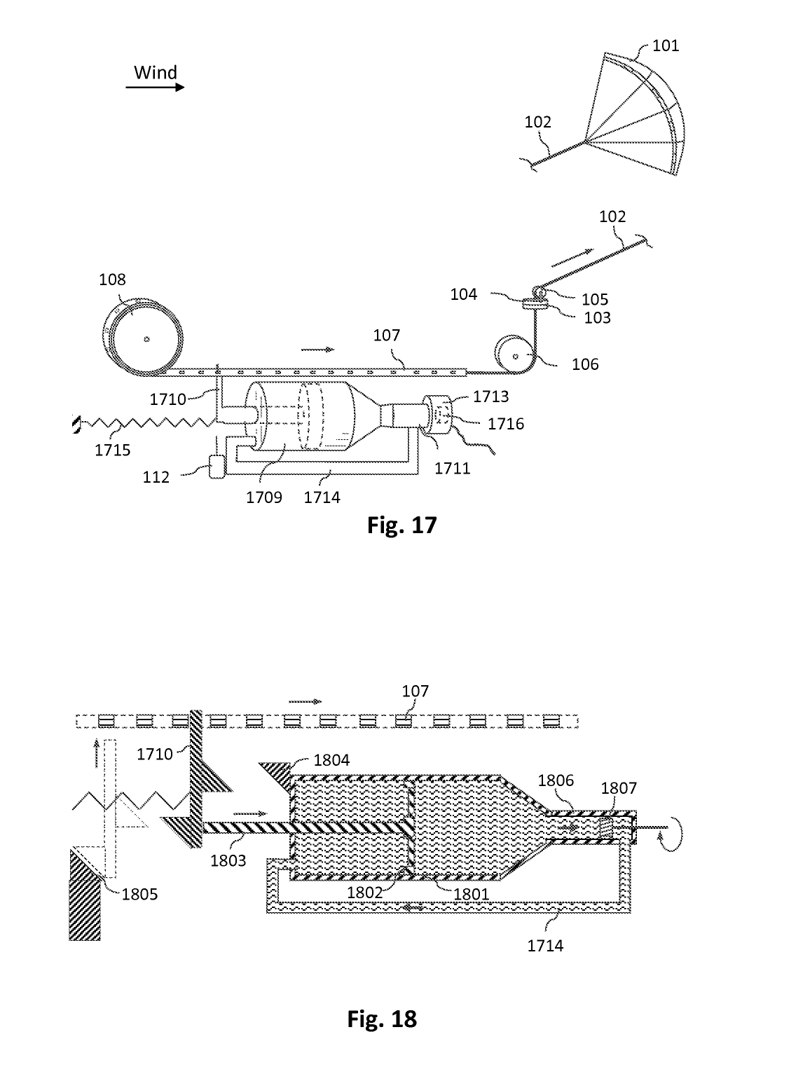

FIG. 17 shows another embodiment of the invention. It comprises airborne wing 101, harvesting wind energy by moving cross wind. Tether 102 is attached to wing 101. Other elements of the construction, shown in FIG. 17 and described below, are installed on the ground. Particulars of attachment of the elements to the walls, ground and other supporting structures are not shown to avoid clutter. There is ring 103, installed on a slightly elevated structure. Another ring 104 is installed on top of ring 103 on ball bearings and is capable of horizontal rotation to accommodate changes in the direction of the wind. Vertical pulley 105 is installed on ring 104. Tether 102 wraps around pulley 104 and drops inside of rings 103 and 104, so that it remains vertical no matter how ring 104 with pulley 105 rotate. Tether 102 goes around vertical pulley 106, as shown in FIG. 17, so that it comes out horizontally. A perforated belt (or a chain) 107 is attached at the end of tether 102 and winds on/unwinds from a spool 108, which is placed at some distance from pulley 106. In the working phase, which will be described below, wing 101 moves generally away from the ground installation, tether 102 moves as shown by an arrow, pulling belt 107, which unwinds from spool 108 and moves to the right. A hydraulic cylinder 1709 is installed on the ground near spool 108, its piston is driven by a pin 1710, engaged by belt 107. Cylinder 1709 and interconnected vessels are filled with a working liquid, such as low viscosity motor oil or water. The right end of cylinder 1709 narrows down and ends in a pipe 1806, narrower than cylinder 1709, which leads into a closed turbine 1711. The axle of turbine 1711 is rotationally connected to the rotor of an electrical generator 1713. A low pressure pipe 1714 connects space behind turbine 1711 to the left end of cylinder 1709, allowing continuous circulation of the working liquid, as shown by small arrows in FIG. 18. There is also a tension spring 1715, attached to a wall and pin 1710. Control system 112 is provided for automatic operation of the system. A rotor 1716 of generator 1713 is shown in the dashed lines.

FIG. 18 shows details of cylinder 1709 and the piping. Cylinder 1709 has walls 1801. A piston 1802 is inserted into cylinder 1709, and attached to a piston rod 1803. Piston rod 1803 is attached to pin 1710 in such way that pin 1710 can glide vertically on piston rod 1803. A triangular flange 1804 is attached to the upper side of cylinder 1709, and another triangular flange 1805 is mounted still on another side from pin 1710. The right end of cylinder 1709 gradually transitions into a narrow pipe 1806. Narrow pipe 1806 leads to turbine 1711, and FIG. 18 shows a rotor 1807 of turbine 1711. Pipe 1714 returns the working liquid from behind rotor 1807 to cylinder 1709 behind piston 1802. Motion of the working liquid is shown by short arrows in FIG. 18.

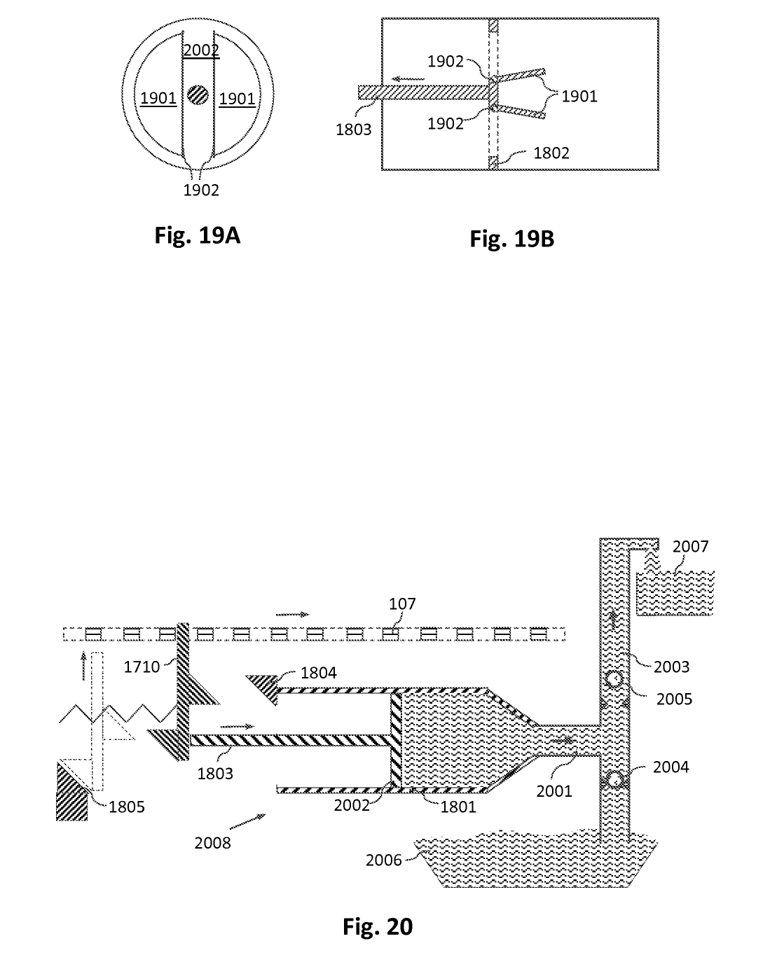

A cylinder cycle begins with a forward stroke, when pin 1710 is engaged with belt 107, moving to the right. Pin 1710 pushes piston 1802 from its left most position to the right, pushing the working liquid. Tension of spring 1715 is small compared with the force exerted by belt 107 on pin 1710. The speed of the working liquid in pipe 1806 is larger than the speed of it in cylinder 1709. The impulse of the working liquid rotates turbine rotor 1807 of turbine 1711. Thus, the power transfer is accomplished according to the scheme: power of the wind is harvested by wing 101—converted and transferred through linear motion of tether 102 and belt 107—converted by piston 1802 into motion of the working liquid—converted by blades of turbine rotor 1807 into rotation of the turbine axle and transferred to rotor 1716 of electrical generator 1713—converted by electrical generator 113 into electrical energy and sent to the consumers through electrical cables. In the end of the forward stroke, the upper flange on pin 1710 meets flange 1804, causing pin 1710 to slide down and disengage from belt 107. Tension of spring 1715 pulls piston 1802 back, starting a back stroke. In order to decrease back pressure in the back stroke, piston 1802 is equipped with opening slots 1901, rotating on axis 1902, as shown in FIG. 19A and FIG. 19B. Slots 1901 close in the forward stroke, and open as shown in FIG. 19B in the back stroke. Thus, the pressure on piston 1802 in the back stroke is very small, and the back stroke can be much shorter than the forward stroke. Turbine rotor 1807 and generator rotor 1716 can disengage when cylinder 1709 is not in the forward stroke (i.e., when it is in the back stroke or the device is in the returning phase). There is a flywheel, rotationally coupled to rotor 1716 that accumulates mechanical energy in the forward stroke and supplies it to the rotor of the electrical generator between the forward strokes. Consequently, the rotational speed of the rotor and AC frequency, supplied by generator 1713, do not drop between the forward strokes. In the end of the back stroke, the lower flange on pin 1710 meets flange 1805, causing pin 1710 to slide up and engage belt 107, and the new cylinder cycle starts.

The whole device operates in cycles (which should be distinguished from the cylinder cycles; the device cycle contains multiple cylinder cycles). Each device cycle consists of a working phase and a returning phase. The working phase starts when most of belt 107 is wound around spool 108, and wing 101 is at its closest position to the ground installation. Wing 101 flies cross wind in a controlled pattern, such as “figure eight”, using aerodynamic lift to pull tether 102. Tether 102 pulls belt 107, which unwinds from spool 108 and brings in motion piston 1802 of cylinder 109, rotating rotor 116 of electrical generator 113, which generates electrical energy. In its upper part, tether 102 has some angle to the horizon, typically in the range 20°-40°. The typical tangential speed of tether 102 is between ⅓ and ⅔ of the scalar value of the projection of the wind velocity on the upper tether part. Wing 101 is controlled in such way that the tension of tether 102 (and, consequently, of belt 107) does not change significantly over the working phase. Arrows in FIG. 17 show the direction of the motion of belt 107 and tether 102 in the working phase. The working phase ends when almost all belt 107 is unwound from spool 108. The returning phase starts. In the returning phase, belt 107 is raised above pin 110 of cylinder 109 (means for raising or lowering belt 107 are not shown in the figures). An external electrical motor (not shown) rotates spool 108 in the opposite direction, winding belt 107 back on spool 108. These operations are performed under command of control system 112. Belt 107 pulls tether 102, which pulls wings 101 closer to the ground installation, toward its original position. In the end of the returning phase, control system 112 orders wing 101 to enter a stable “figure eight” trajectory. Then belt 107 is lowered and starts unwinding from spool 108, engaging pin 1710, and a new working phase starts. One advantage of this device is that it allows conversion energy of the relatively slow moving tether into relatively fast (1,500-1,800 RPM) rotational motion of the rotor of the electrical generator at low cost. This allows performing energy conversion at much lower cost per kW and/or kWh than by existing devices. Sample system parameters:

Belt 107 speed (working phase): 6 m/s; belt 107 length: 120 m; cylinder 1709 diameter: 2 m; cylinder 1709 length: 3 m; pipe 1806 diameter: 0.5 m; speed of liquid in pipe 1806: 96 m/s; device cycle: 25 s; working phase: 20 s; cylinder cycle: 0.5 s; tether 102 tension: 70 MN; turbine rotor 1807 RPM: 1,800; peak power: 40 MW; average power: 30 MW

This device can be modified in multiple ways. For example, multiple cylinders 1709 can be used with a single turbine 1711. A hydraulic motor of a different type can be used in place of turbine 1711. Belt 107 can be replaced with a rod, having teeth or holes for pin 110. Spring 1715 can be replaced with a small electrical motor, which pulls piston 1802 in the backstroke and does not pull it in the forward stroke.

Another embodiment of the invention is a device for pumping water, shown in FIG. 20. This device comprises the same airborne elements and many similar mechanical elements, as the device in FIG. 17, so the following description focuses on the differences. The pumping device has a cylinder 2008, comprising a piston 2002, piston rod 1803 and cylinder walls 1801. A back end wall is optional. Cylinder 2008 transitions into a pipe 2001, which is not necessarily narrower than cylinder 2008. There is a lower reservoir 2006 and an upper reservoir 2007. Cylinder 2008 is installed at the altitude of the surface of lower reservoir 2006. A pipe 2003 is provided, having a lower opening in lower reservoir 2006 and an upper opening into upper reservoir 2007. There are also a lower valve 2004 and an upper valve 2005. In the forward stroke, piston 2002 moves to the right, displacing the water in pipe 103 up and into upper reservoir 2007. Lower valve 2004 is closed and upper valve 2005 is open by the force of the moving water. In the backward stroke, piston 2002 moves to the left, sucking in (with relatively small pressure) the water from lower reservoir 2006. Lower valve 2004 is open and upper valve 2005 is closed by the force of the moving water. Pipe 2007 does not have to be straight or vertical, and it does not have to be in the plane of belt 107. This embodiment can be used for many purposes, among them water transportation, energy accumulation as a part of a pumped storage plant or a hydro-electrical power station, irrigation etc.

Lower reservoir 2006 can be a natural or an artificial pond, a lake, a river, a sea, an ocean, an underground reservoir and other. Upper reservoir 2007 can be a natural or an artificial pond, a lake, a river (even a higher part of the same river, as the lower reservoir), an artificial vessel, a channel and other. It should be noticed, that many places, where the mountains border the ocean, are suitable to deploying an airborne wind energy conversion system with pumped storage according to this aspect of the invention. In such an installation, the ocean would serve as lower reservoir 2006 and some natural or artificial reservoir in the mountains would serve as upper reservoir 2007. Cylinder 2008 can be also installed at the altitude of the surface of upper reservoir 2007, in which case the cylinder's direction should be reversed to perform most of the work in the suction. A pumped hydro energy system, using the device from FIG. 20, can be combined with a device from FIG. 17, or with another wind energy conversion system, to create a wind farm with firm capacity.

Thus, an airborne wind energy system for electricity generation, energy storage, and other uses is described in conjunction with one or more specific embodiments. While above description contains many specificities, these should not be construed as limitations on the scope, but rather as exemplification of several embodiments thereof. Many other variations are possible.

What is claimed is:

1. A system for converting wind energy into internal energy of gas, comprising:
an airborne member, adapted to harvest wind energy;
a tether, attaching the airborne member to the ground;
a gas compressor at the ground level, coupled to the airborne member;
the gas compressor utilizing at least one gas tight piston, coupled to the tether, as the surface compressing the gas; and
the gas compressor being adapted to output compressed hot gas for utilization in an industrial process.

2. The system of claim 1, wherein the industrial process is shale oil extraction.

3. The system of claim 1, wherein the industrial process is synthetic fuel production.

4. The system of claim 1, wherein the industrial process is hydrocarbons cracking.

5. The system of claim 1, wherein the industrial process is water desalination.

6. An energy storage device, comprising the system of claim 1 and:
a storage medium, adapted to receive the internal energy of the compressed hot gas;
a heat engine, adapted to use the energy from the storage medium;
an electrical generator, driven by the heat engine.

7. The system of claim 6, wherein the storage medium contains compressed air.

8. The system of claim 6, wherein the storage medium contains supercritical water.

9. The system of claim 6, wherein the storage medium contains heated liquid.

10. The system of claim 6, wherein the storage medium contains heated solid.

11. The system of claim 6, wherein the storage medium contains cooled solid.

12. The system of claim 6, wherein the storage medium comprises sorptive substance.

13. The system of claim 6, wherein more than half of the stored energy is stored in the form of sensitive heat.

14. The system of claim 6, wherein more than half of the stored energy is stored in the form of latent heat.

15. A natural gas power plant, comprising the system of claim 1, adapted to compress air in which the natural gas combusts.

16. A wind power plant, designed to produce at least a pre-defined minimum power for at least pre-defined percentage of time, the wind power plant comprising:
a first airborne wind energy conversion system, comprising an electrical generator, adapted to convert power of wind into electrical power;
an energy storage;
a second airborne wind energy conversion system, adapted to convert power of wind into internal energy of matter, stored in the energy storage;
an energy conversion system, comprising an electrical generator, adapted to convert the internal energy of matter, stored in the energy storage, into electrical power; and
a control system.

17. The system of claim 16, wherein the pre-defined percentage of time is at least 80%.
